(19) United States
(12) Patent Application Publication
(10) Pub. No.: US 2026/0185621 A1
(43) Pub. Date: Jul. 2, 2026

(54) VORTEX-TYPE FLOW CONTROL VALVE

(71) Applicant: ASAHI YUKIZAI CORPORATION, Nobeoka-shi, Miyazaki (JP)

(72) Inventor: Kota KUMAMOTO, Nobeoka-shi, Miyazaki (JP)

(21) Appl. No.: 18/868,174

(22) PCT Filed: May 22, 2023
(86) PCT No.: PCT/JP2023/019010

§ 371 Date: Nov. 22, 2024

(30) Foreign Application Priority Data
May 23, 2022 (JP) 2022-084138

(51) Int. Cl. F16K 13/10; F16K 7/12

(52) U.S. Cl. CPC F16K 13/10; F16K 7/12

(57) ABSTRACT

A vortex flow rate adjustment valve includes: a vortex chamber that is defined by a cylindrical peripheral wall, and a first end wall and a second end wall provided at both ends of the peripheral wall; an inlet flow path that extends along an inlet flow path center axis and opens in the peripheral wall; an outlet flow path that extends along an outlet flow path center axis and opens into the first end wall. The inlet flow path center axis passes through a position away from a vortex chamber center axis and the outlet flow path center axis. The second end wall is movable toward and away from the first end wall by a drive unit. The flow rate of fluid flowing out from the outlet flow path is adjusted according to amount of movement of the second end wall with respect to the first end wall.

### TECHNICAL FIELD

The present invention relates to a flow control valve, which is used for fluid transport piping liens in various industrial fields, such as chemical factories, semiconductor manufacturing fields, liquid crystal manufacturing fields, and food fields.

### BACKGROUND ART

A needle valve is generally used in applications for adjusting flow rates in various industrial fields. For example, as described in PTL1, the needle valve inserts a tapered tip part of a valve element called a needle into a valve seat having a through-hole and moves a peripheral surface of the tip part of the needle closer to or away from the valve seat to change a gap between the needle and the valve seat, thereby adjusting a flow rate of fluid flowing through the gap between the needle and the valve seat. In order to enable fine adjustment of the flow rate, the gap between the needle and the valve seat is narrower than other flow passages in the needle valve. In particular, the gap between the needle and the valve seat is extremely narrow in the vicinity of a lower limit of an operating flow rate range of the needle valve.

### CITATION LIST

### Patent Documents

PTL1: Japanese Patent No. 5144880
PTL2: Japanese examined Utility Model Publication No. S59-5209

### SUMMARY OF THE INVENTION

### Technical Problem

As described above, in the needle valve, the gap between the needle and the valve seat is narrow, and particularly, the gap between the needle and the valve seat is extremely narrow in the vicinity of the lower limit of the operating flow rate range of the needle valve. Therefore, if coaxiality between the needle and the valve seat is poor, the needle and the valve seat, which should not originally come into contact with each other, may come into contact with each other and slide on each other when the flow rate is adjusted to a low flow rate, resulting in abrasion of the needle and the valve seat. When such abrasion occurs, the gap between the needle and the valve seat, that is, the relationship between the opening degree of the needle valve and the flow rate, is changed, and it is difficult to adjust the flow rate accurately. In addition, particles generated due to the abrasion are mixed in the fluid. Such mixing of the particles into the fluid is a significant problem, particularly in the semiconductor manufacturing field. In a case where the needle is driven by an electric actuator and the flow rate is frequently adjusted by feedback control or the like, the needle is constantly reciprocated, making the above-described problem particularly noticeable. When the relationship between the opening degree of the needle valve and the flow rate is changed, it is necessary to adjust control parameters in feedback control or the like again. In such a case, the needle valve is often replaced, in effect, as the needle valve has come to the end of the life, leading to increased maintenance costs.

As a method for avoiding sliding between the valve element and the valve seat, there is, for example, a method using a vortex-type fluid element that utilizes swirling flow, as disclosed in PTL2. The vortex-type fluid element disclosed in PTL2 consists of a vortex chamber having an output port at a center part thereof, an input nozzle connected to an outer peripheral part of the vortex chamber and restricting a direction of fluid from an input port toward the output port, and a control nozzle that ejects a control flow for turning the fluid ejected from the input nozzle into a vortex flow in the vortex chamber near an outlet of the nozzle to the vortex chamber. In an interference area, the control flow ejected from the control nozzle is deflected by colliding with a jet flow ejected from the input nozzle to generate the vortex flow in the vortex chamber. Generation of the vortex flow causes a pressure difference between the interference area and the output port to increase flow rate resistance, thereby controlling an output flow rate. However, although the valve element and the valve seat do not come into contact with each other in such a vortex-type fluid element, it is necessary to adjust the flow rate of the control flow ejected from the control nozzle in order to control the flow rate. Therefore, a flow control valve is required in the flow rate adjustment of the control flow, which ultimately leaves a possibility of particles being mixed into the control flow.

Accordingly, an object of the present invention is to solve the problems existing in the prior art and to provide a flow control valve in which contact between a valve element and a valve seat does not occur in an area that is in contact with the fluid to be controlled.

### Solution to Problem

In view of the above-described object, the present invention provides a vortex-type flow control valve including: a vortex chamber defined by a cylindrical peripheral side wall, a first end wall, and a second end wall, the first end wall and the second end wall provided opposite each other at both ends of the peripheral side wall, the vortex chamber extending along a vortex chamber central axis; an inlet flow passage extending along an inlet flow passage central axis and being opened in the peripheral side wall; and an outlet flow passage extending along an outlet flow passage central axis and being opened in the first end wall, the vortex-type flow control valve configured such that fluid flowing in from the inlet flow passage generates a vortex flow in the vortex chamber and flows out into the outlet flow passage, in which the inlet flow passage is provided such that the inlet flow passage central axis extends through a position away from the vortex chamber central axis and the outlet flow passage central axis, and the second end wall is configured to be movable closer to or away from the first end wall by a drive unit, the vortex-type flow control valve is configured such that a flow rate of the fluid flowing out into the outlet flow passage is adjusted in accordance with an amount of movement of the second end wall with respect to the first end wall.

In the above-described vortex-type flow control valve, the vortex chamber extending along the vortex chamber central axis is defined by the cylindrical peripheral side wall, and the first and second end walls provided opposite each other at both ends of the peripheral side wall, the inlet flow passage is provided such that the inlet flow passage central axis of the inlet flow passage being opened in the peripheral side wall extends through the position away from the vortex chamber central axis and the outlet flow passage central axis, and the outlet flow passage is opened in the first end wall. Therefore, the fluid flowing in from the inlet flow passage flows out into the outlet flow passage after generating a swirling flow in the vortex chamber to flow in a vortex shape. As a result, a pressure loss is generated in accordance with a flow velocity and a length of the swirling flow from the inflow through the inlet flow passage to the outflow into the outlet flow passage (that is, a length of a flow line of the vortex flow). In addition, when the second end wall defining the vortex chamber is moved closer to or away from the first end wall by the drive unit, a height of a space in which the vortex flow in the vortex chamber can flow (distance between the first end wall and the second end wall) is changed to thereby increase or decrease an area through which the fluid can flow. As a result, the flow velocity of the vortex flow in the vortex chamber is changed to be increased or decreased. As described above, the pressure loss of the fluid flowing from the inlet flow passage to the outlet flow passage in the vortex chamber depends on the flow velocity and the length of the flow line of the swirling flow (vortex flow) from the inflow through the inlet flow passage to the outflow into the outlet flow passage. Therefore, when the flow velocity of the vortex flow of the fluid in the vortex chamber is increased, the pressure loss generated while the fluid flows from the inlet flow passage to the outlet flow passage is increased and the flow rate of the outflow into the outlet flow passage is decreased. On the other hand, when the flow velocity of the vortex flow of the fluid in the vortex chamber is decreased, the pressure loss generated while the fluid flows from the inlet flow passage to the outlet flow passage is decreased and the flow rate of the outflow into the outlet flow passage is increased. Utilizing such characteristics, the flow rate of the fluid flowing out into the outlet flow passage can be adjusted by using the drive unit to move the second end wall closer to or away from the first end wall.

In the above-described vortex-type flow control valve, the second end wall can be constituted by a diaphragm moved closer to or away from the first end wall by the drive unit. In a case where the second end wall is constituted by such a diaphragm, the second end wall can be moved closer to or away from the first end wall with a simple structure, without providing a portion where sliding or contact occurs.

In this case, the diaphragm may include, for example, a movable portion moved by the drive unit, and an elastically deformable supporting portion which is connected to an outer peripheral edge of the movable portion and supports the movable portion, or may include a movable portion moved by the drive unit, and a flexible or bendable supporting portion which is connected to an outer peripheral edge of the movable portion and supports the movable portion.

It is preferable that the outlet flow passage is provided such that the outlet flow passage axis extends on the vortex chamber central axis.

Further, in the vortex-type flow control valve, the first end wall may be provided thereon with a protruding portion protruding toward the diaphragm. By providing the protruding portion, the protruding portion hinders the vortex flow and makes it easier to direct the fluid toward the outlet flow passage, and a distance of fluid flowing from the inlet flow passage to the outlet flow passage is shortened to decrease the pressure loss, which makes it possible to achieve an effect of increasing the flow rate.

It is preferable that the first end wall and the second end wall have a circular shape or an elliptical shape. In such a case, since the vortex chamber has a circular cylindrical shape or an elliptical cylindrical shape, the fluid flowing into the vortex chamber from the inlet flow passage flows along the peripheral side wall and is likely to generate the vortex flow.

### Advantageous Effect of the Invention

According to the present invention, the vortex flow is generated in the vortex chamber and the flow velocity of the vortex flow in the vortex chamber is increased or decreased by moving the second end wall closer to or away from the first end wall to change the area through which the vortex flow can flow. Utilizing such characteristics, the pressure loss generated while the fluid flows from the inlet flow passage to the outlet flow passage can be changed by using the drive unit to move the second end wall closer to or away from the first end wall, thereby adjusting the flow rate of the fluid flowing out into the outlet flow passage. Therefore, in a case where the vortex-type flow control valve according to the present invention is used, it is not required to provide the valve element and the valve seat in a region in contact with the fluid to be controlled, and it is possible to eliminate a contact portion between the valve element and the valve seat. As a result, it is not required to reset the parameters for flow rate control due to the abrasion of the valve element and the valve seat, and the mixing of the particles into the fluid can be suppressed.

### BRIEF DESCRIPTION OF DRAWINGS

FIG. 1 is a partially broken perspective view showing an overall configuration of a vortex-type flow control valve according to the present invention with a part being broken off so that the interior thereof can be seen.

FIG. 2 is a plan view of the vortex-type flow control valve shown in FIG. 1 as seen from above in FIG. 1.

FIG. 3 is a side view of the vortex-type flow control valve shown in FIG. 1 as viewed from a side of FIG. 1.

FIG. 4 is an explanatory diagram schematically showing a flow in a vortex chamber of the vortex-type flow control valve shown in FIG. 1.

FIG. 5A is an explanatory diagram schematically showing an operation of a vortex-type flow control valve according to a first embodiment.

FIG. 5B is an explanatory diagram schematically showing the operation of the vortex-type flow control valve according to the first embodiment.

FIG. 5C is an explanatory diagram schematically showing the operation of the vortex-type flow control valve according to the first embodiment.

FIG. 6A is an explanatory diagram schematically showing an operation of a vortex-type flow control valve according to a second embodiment.

FIG. 6B is an explanatory diagram schematically showing the operation of the vortex-type flow control valve according to the second embodiment.

FIG. 6C is an explanatory diagram schematically showing the operation of the vortex-type flow control valve according to the second embodiment.

FIG. 7A is an explanatory diagram schematically showing an operation of a variation of the vortex-type flow control valve according to the second embodiment.

FIG. 7B is an explanatory diagram schematically showing the operation of the variation of the vortex-type flow control valve according to the second embodiment.

FIG. 7C is an explanatory diagram schematically showing the operation of the variation of the vortex-type flow control valve according to the second embodiment.

FIG. 8A is an explanatory diagram for illustrating a configuration and dimensions of a vortex-type flow control valve used in a numerical simulation, and shows the vortex-type flow control valve with an upper end wall (second end wall) removed, as viewed from above.

FIG. 8B is an explanatory diagram for illustrating the configuration and the dimensions of the vortex-type flow control valve used in the numerical simulation, and shows the vortex-type flow control valve as viewed from a side.

FIG. 9 is a line graph plotting measurement results of a relationship between a movement distance of a diaphragm in a direction from a home position toward a first end wall and a flow rate Q, which measurement results were obtained when a position of an inlet flow passage is changed in the numerical simulation using the vortex-type flow control valve shown in FIGS. 8A and 8B.

FIG. 10 is a line graph plotting a relationship between the position of the inlet flow passage and a flow rate difference ΔQ (change amount of the flow rate into the outlet flow passage) when the movement distance of the diaphragm is changed in a range of 0.5 mm to 5.5 mm, which relationship was obtained by the numerical simulation using the vortex-type flow control valve shown in FIGS. 8A and 8B.

FIG. 11 is an explanatory diagram schematically showing a vortex-type flow control valve according to a third embodiment of the present invention.

FIG. 12A is an explanatory diagram schematically showing a vortex-type flow control valve according to a fourth embodiment of the present invention, and illustrates a state where a second end wall is arranged at a home position.

FIG. 12B is an explanatory diagram schematically showing the vortex-type flow control valve according to the fourth embodiment of the present invention, and illustrates a state where the second end wall is moved toward a first end wall.

### DESCRIPTION OF EMBODIMENTS

Embodiments of a vortex-type flow control valve according to the present invention will be described below with reference to the drawings.

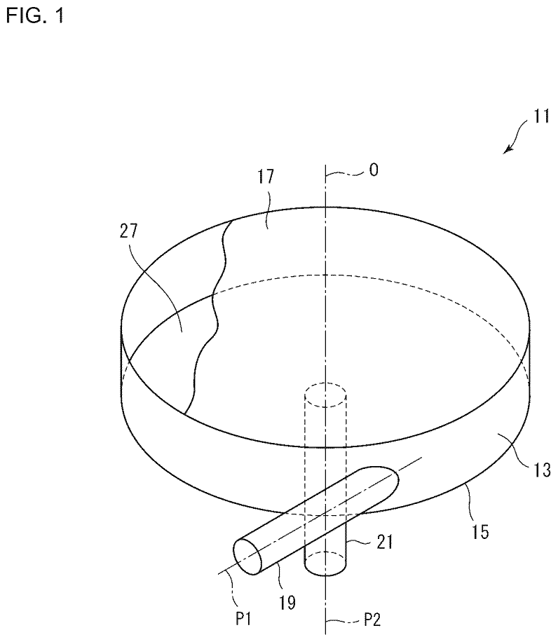

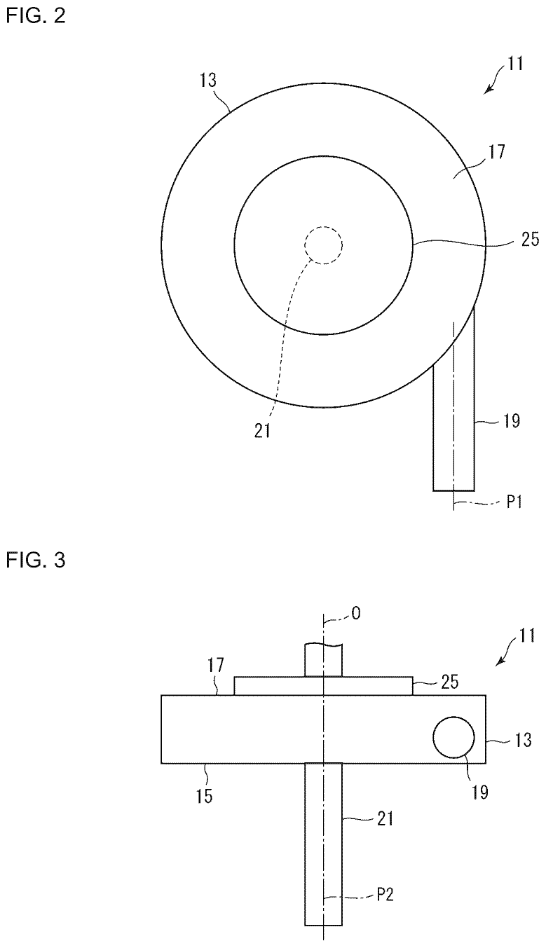

First, an overall configuration of a vortex-type flow control valve 11 according to the present invention will be described with reference to FIGS. 1 to 3.

The vortex-type flow control valve 11 includes a cylindrical peripheral side wall 13 extending along a central axis, a first end wall 15 and a second end wall 17 that are provided opposite each other at both ends of the peripheral side wall 13 in a central axis direction, an inlet flow passage 19, and an outlet flow passage 21, so that the second end wall 17 can be moved closer to or away from the first end wall 15. The first end wall 15 and the second end wall 17 are provided so as to close end parts of the peripheral side wall 13 in the central axis direction, and a space surrounded by the peripheral side wall 13, the first end wall 15, and the second end wall 17 constitutes a cylindrical vortex chamber 27 extending along a vortex chamber central axis O. The vortex chamber central axis O coincides with the central axis of the peripheral side wall 13. In the present specification, the “center” refers to a centroid of a cross section of a specified portion, and the vortex chamber central axis refers to an axis extending to pass through a centroid position of each cross section of the vortex chamber 27 perpendicular to the vortex chamber central axis O. In the shown embodiment, the first end wall 15 and the second end wall 17 have a circular shape of the same size, the peripheral side wall 13 has a circular cylindrical shape, and the vortex chamber central axis O extends to connect a center (centroid) of the first end wall 15 and a center (centroid) of the second end wall 17. However, the shapes of the first end wall 15 and the second end wall 17 are not limited to a circular shape, and can be any shape such as an elliptical shape or a polygonal shape such as a triangular shape or a quadrangular shape, as long as a vortex flow can be generated in the vortex chamber 27. The first end wall 15 and the second end wall 17 are not limited to flat surfaces and may be formed by, for example, a curved surface.

The inlet flow passage 19 extends along an inlet flow passage central axis P1 perpendicular to the vortex chamber central axis O and is opened in the peripheral side wall 13. The inlet flow passage central axis P1 extends to pass through a center of a cross section of the inlet flow passage 19. The outlet flow passage 21 extends from the vortex chamber 27 to the outside along an outlet flow passage central axis P2 parallel to the vortex chamber central axis O and is opened in the first end wall 15 of the vortex chamber 27. The outlet flow passage central axis P2 extends to pass through a center of a cross section of the outlet flow passage 21. In the shown embodiment, both the inlet flow passage 19 and the outlet flow passage 21 are constituted by circular pipes each having a circular cross-sectional shape. However, the cross sections of the inlet flow passage 19 and the outlet flow passage 21 are not limited to the circular shape, but can also be a polygonal shape such as an elliptical shape or a quadrangular shape. In the shown embodiment, the inlet flow passage 19 is constituted by a straight circular pipe, but may have other shapes such as a nozzle shape as long as the fluid can flow into the vortex chamber 27.

The inlet flow passage 19 is provided such that the inlet flow passage central axis P1 extends through an eccentric position away from the vortex chamber central axis O. Therefore, the fluid flowing into the vortex chamber 27 from the inlet flow passage 19 hits the peripheral side wall 13 in the vortex chamber 27 and flows along the peripheral side wall 13 to generate a swirling flow, which then becomes a vortex flow to the outlet flow passage 21 and flows out into the outlet flow passage 21. It is preferable that the inlet flow passage 19 is provided so that the fluid flowing into the vortex chamber 27 from the inlet flow passage 19 flows along the peripheral side wall 13 in order to facilitate the generation of a swirling flow. On the other hand, the outlet flow passage 21 can be provided at any position of the first end wall 15 as long as the fluid flowing into the vortex chamber 27 from the inlet flow passage 19 flows out into the outlet flow passage 21 after the vortex flow is generated. In other words, the outlet flow passage 21 may be provided so that the outlet flow passage central axis P2 extends through a position away from the inlet flow passage central axis P1 in order to prevent the fluid flowing into the vortex chamber 27 through the inlet flow passage 19 from flowing out into the outlet flow passage 21 as it is.

In the shown embodiment, the inlet flow passage 19 is connected to the peripheral side wall 13 such that the inlet flow passage 19 extends in a tangential direction of the cylindrical peripheral side wall 13 and the inlet flow passage central axis P1 extends parallel to a tangential line, so that the fluid flows into the vortex chamber 27 from the inlet flow passage 19 in a direction substantially tangential to the peripheral side wall 13. The outlet flow passage 21 is opened in the first end wall 15, so that the outlet flow passage 21 is provided such that the outlet flow passage central axis P2 extends to pass through the center of the first end wall 15, that is, the outlet flow passage central axis P2 extends on the vortex chamber central axis O. This configuration allows the fluid flowing in from the inlet flow passage 19 to flow along the peripheral side wall 13 in the vortex chamber 27, thereby generating the swirling flow to gradually move closer to the center part and flowing toward the outlet flow passage 21 in a vortex-like manner.

At least a part of the second end wall 17 is driven by the drive unit 25 to be movable relative to the first end wall 15 along a movement axis extending parallel to the vortex chamber central axis O in the vortex chamber 27. As the drive unit 25, for example, an appropriate mechanism, such as an electric actuator, can be used as long as the second end wall 17 is configured to be movable. Further, the drive unit 25 can adopt various drive methods such as a manual method, an air drive method, and an electric method. By using the drive unit 25 to move at least a part of the second end wall 17 in the vortex chamber 27, a distance (that is, a gap) between the first end wall 15 and the second end wall 17 is changed. Accordingly, a volume of the space in which the fluid flows can be changed to thereby increase or decrease a flow area of the fluid. In FIG. 1, the drive unit 25 is omitted for ease of illustration.

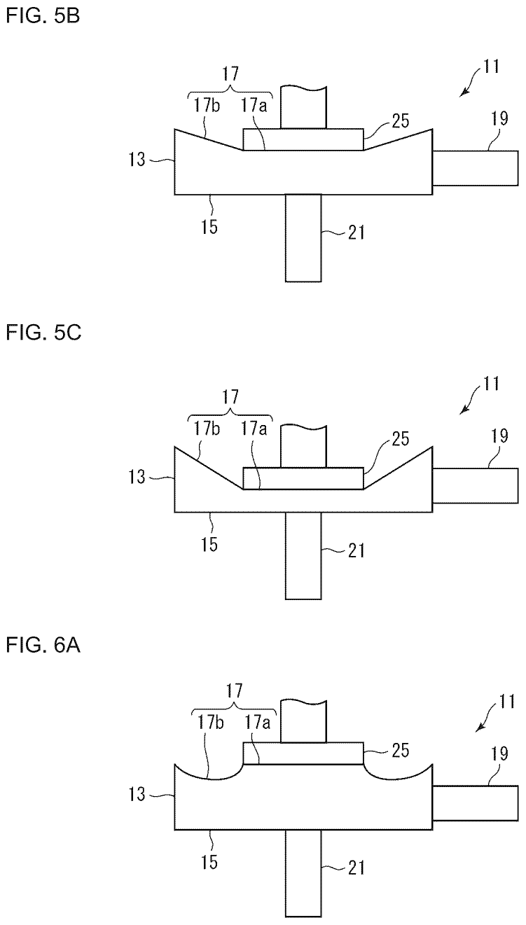

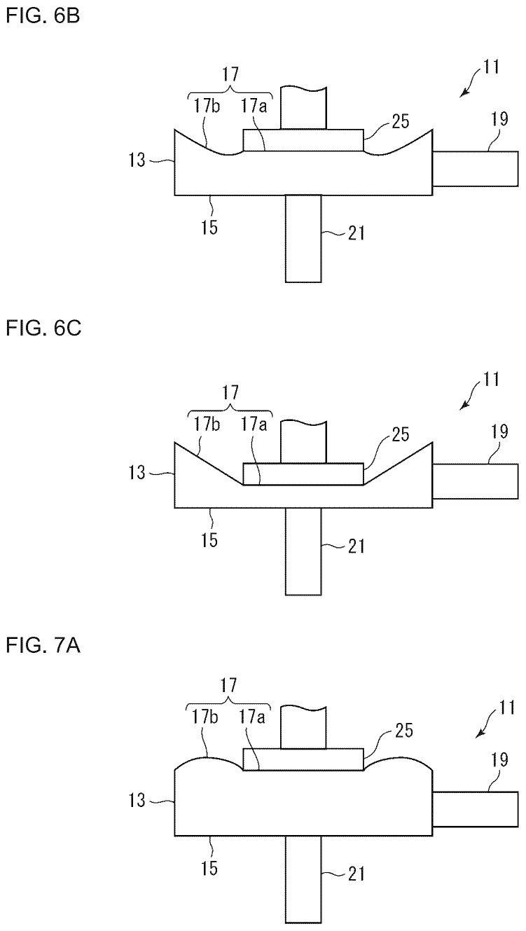

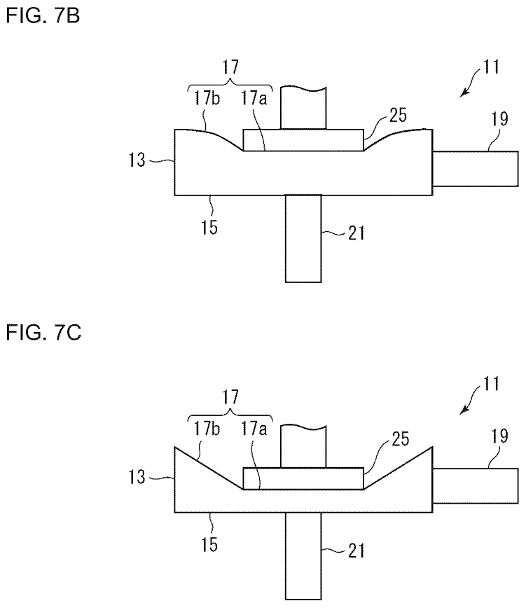

In the vortex-type flow control valve 11, the second end wall 17 can be constituted by a diaphragm including a movable portion 17a moved by the drive unit 25 and a deformable supporting portion 17b which is connected to extend between an end of the peripheral side wall 13 in a direction of the vortex chamber central axis O and an outer peripheral edge of the movable portion 17a and supports the movable portion. For example, as a first embodiment of the vortex-type flow control valve 11, the supporting portion 17b of the diaphragm, which constitutes the second end wall 17, may be formed of an elastic material so that the supporting portion 17b is elastically deformable and the movable portion 17a is movable relative to the first end wall 15 (see FIGS. 5A to 5C). In this case, it is preferable that the movable portion 17a is also formed of the same type of elastic material as the supporting portion 17b in order to facilitate the manufacturing of the diaphragm. However, since the movable portion 17a is movable as long as the supporting portion 17b is formed of an elastic material, it goes without saying that the movable portion 17a may be formed of different types of elastic materials or non-elastic materials. As a second embodiment of the vortex-type flow control valve 11, the supporting portion 17b of the diaphragm, which constitutes the second end wall 17, may be formed of a flexible material so that the supporting portion 17b is flexible or bendable and the movable portion 17a is movable relative to the first end wall 15. In this case, at a home position described later, the supporting portion 17b may be arranged to be convexly curved so as to protrude toward the first end wall 15 (see FIGS. 6A to 6C), or the supporting portion 17b may be arranged to be convexly curved so as to protrude in a direction away from the first end wall 15 (see FIGS. 7A to 7C).

Further, in the shown embodiment, a push rod driven by an electric actuator is used as the drive unit 25, so that the movable portion 17a of the diaphragm can be moved relative to the first end wall 15 by the push rod pressing the movable portion 17a of the diaphragm to deform the supporting portion 17b that supports the movable portion 17a. However, the drive unit 25 is not limited to the push rod driven by the electric actuator as long as the movable portion 17a is movable relative to the first end wall 15. For example, a push rod driven manually or by air driving may be used as the drive unit 25. In addition, other mechanisms, such as a piston cylinder, can also be used as the drive unit 25, as long as the supporting portion 17b can be deformed by pressing the movable portion 17a of the diaphragm.

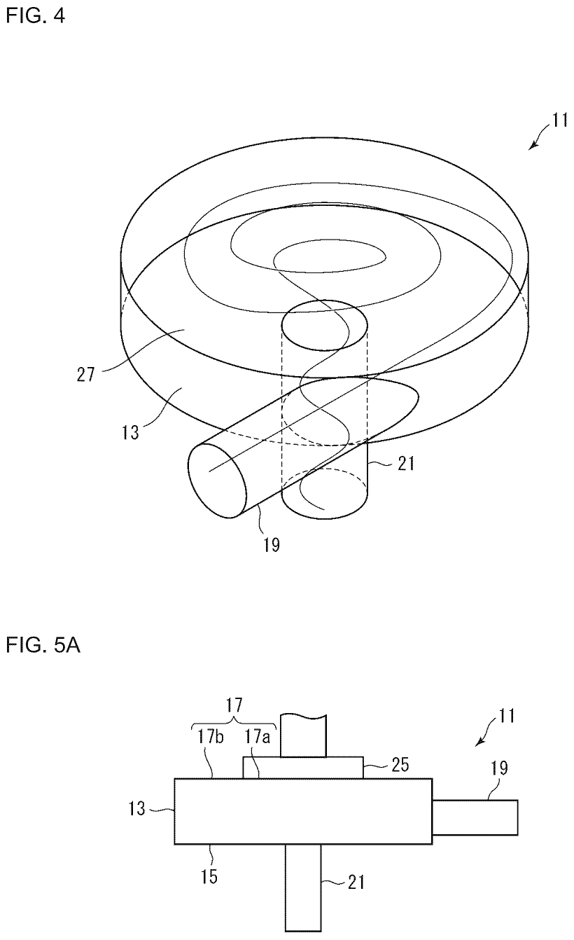

Next, an action of the vortex-type flow control valve 11 according to the present invention will be described with reference to FIGS. 4 and 5A to 5C by using the vortex-type flow control valve 11 according to the first embodiment as an example.

As described above, the inlet flow passage 19 is provided such that the inlet flow passage central axis P1 extends through the eccentric position away from the vortex chamber central axis O. Therefore, as shown in FIG. 4, the fluid flowing in from the inlet flow passage 19 generates the swirling flow in the vortex chamber 27, is directed toward the outlet flow passage 21 while swirling, and flows out into the outlet flow passage 21. In a state where the diaphragm, which is the second end wall 17, is not pressed by the drive unit 25, the diaphragm is positioned at the home position shown in FIG. 5A. From this state, as shown in FIG. 5B, when the second end wall 17 (in the first embodiment, the movable portion 17a) is pressed by the drive unit 25 to be moved closer to the first end wall 15 on which the outlet flow passage 21 is provided, the distance between the first end wall 15 and the second end wall 17 is shortened, that is, the gap becomes smaller. In the first embodiment shown in FIGS. 5A to 5C, the movable portion 17a pressed by the drive unit 25 elastically deforms the supporting portion 17b, and at least shortens the distance between the movable portion 17a and the first end wall 15. As a result, an area through which the fluid of the vortex flow generated in the vortex chamber 27 can pass is reduced, and a flow velocity of the vortex flow is increased. The fluid that flows into the vortex chamber 27 from the inlet flow passage 19, generates the vortex flow, flows toward the outlet flow passage 21 and flows out into the outlet flow passage 21 generates a pressure loss in accordance with the flow velocity and a distance over which the fluid has flowed. Therefore, when the second end wall 17 is moved closer to the first end wall 15 as described above, the flow velocity is increased and the pressure loss is increased as compared with the state shown in FIG. 5A. As a result, the flow rate of the fluid flowing out into the outlet flow passage 21 is decreased. When the second end wall 17 (in the first embodiment, the movable portion 17a) is further pressed by the drive unit 25 from the state shown in FIG. 5B and is further moved closer to the first end wall 15 as shown in FIG. 5C, the flow velocity of the vortex flow is further increased and an even larger pressure loss is generated. As a result, the flow rate of the fluid flowing out into the outlet flow passage 21 is further decreased as compared with the state shown in FIG. 5B.

A As described above, in the vortex-type flow control valve 11, when the second end wall 17 is moved in a direction of being moved closer to the first end wall 15 to decrease the gap between the first end wall 15 and the second end wall 17, the pressure loss of the fluid flowing from the inlet flow passage 19 to the outlet flow passage 21 is increased and the flow rate of the fluid flowing out into the outlet flow passage 21 is decreased. In other words, by increasing a movement distance of the second end wall 17 from the home position in a direction of being moved closer to the first end wall 15 and decreasing the area through which the fluid of the vortex flow generated in the vortex chamber 27 can pass, the pressure loss of the fluid flowing from the inlet flow passage 19 to the outlet flow passage 21 can be increased and the flow rate of the fluid flowing out into the outlet flow passage 21 can be decreased. On the other hand, by shortening the movement distance of the second end wall 17 from the home position in the direction of being moved closer to the first end wall 15 and increasing the area through which the fluid of the vortex flow generated in the vortex chamber 27 can pass, the pressure loss of the fluid flowing from the inlet flow passage 19 to the outlet flow passage 21 can be decreased and the flow rate of the fluid flowing out into the outlet flow passage 21 can be increased. Therefore, by moving or deforming the second end wall 17 with respect to the first end wall 15 so as to change the gap between the first end wall 15 and the second end wall 17, the flow rate of the fluid flowing out into the outlet flow passage 21 can be adjusted and function as the flow control valve can be exhibited, without providing an abutting portion at a portion in contact with the fluid to be controlled. It goes without saying that the same applies to the second embodiment of the vortex-type flow control valve 11 shown in FIGS. 6A to 6C and FIGS. 7A to 7C.

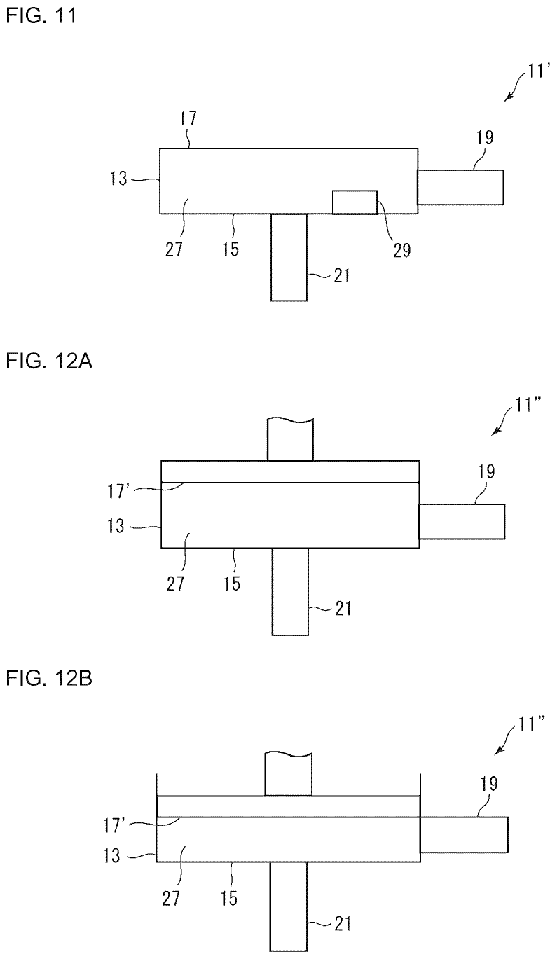

As can be seen from the above description, in the vortex-type flow control valve 11, since the flow rate of the fluid flowing out into the outlet flow passage 21 can be changed as long as the gap between the first end wall 15 and the second end wall 17 can be changed, the present invention is not limited to the shown embodiment. In other words, a wide range of variations of the vortex-type flow control valve 11 according to the present invention is possible. For example, the second end wall 17 need only be moved closer to or away from the first end wall 15 by the movable portion 17a being pressed to deform the supporting portion 17b, and the position of the movable portion 17a need not be in the center part of the second end wall 17. In addition, as in a third embodiment of a vortex-type flow control valve 11′ shown in FIG. 11, the first end wall 15 may be provided with the protruding portion 29 and the second end wall 17 may be brought closer to or away from the protruding portion 29 to change the gap between the top part of the protruding portion 29 and the second end wall 17. Further, as in a fourth embodiment of a vortex-type flow control valve 11″ shown in FIG. 12, instead of having the second end wall 17 be moved closer to or away from the first end wall 15 by deformation, a second end wall 17′ may be configured to be movable along the peripheral side wall 13, and the gap between the first end wall 15 and the second end wall 17′ may be changed by moving the second end wall 17′ along the peripheral side wall 13 as shown in FIG. 12B from the home position shown in FIG. 12A.

In FIG. 11 and FIG. 12, the components common to the components of the vortex-type flow control valve 11 according to the embodiment shown in FIG. 1 are denoted by the same reference numerals. Also in the vortex-type flow control valve 11′ and the vortex-type flow control valve 11″, the second end wall 17 or the second end wall 17′ is moved closer to or away from the first end wall 15 in the same way as in the vortex-type flow control valve 11 of the embodiment shown in FIG. 1, and it is also similar in that the flow rate is adjusted by changing the distance (gap) between the first end wall 15 and the second end wall 17. Therefore, the detailed description of the configuration and the action will be omitted here.

### EXAMPLES

The following describes relationships between the movement distance from the home position of the diaphragm constituting the second end wall 17, the position of the inlet flow passage 19 relative to the outlet flow passage 21, and the flow rate or the flow rate change amount of the fluid, which relationships were obtained by the numerical simulation (hereinafter, simply referred to as a simulation) using the vortex-type flow control valve having the same configuration as the vortex-type flow control valve 11 according to the embodiment shown in FIG. 1. In the following description, for ease of understanding, the respective configurations of the vortex-type flow control valve used in the simulation are denoted by the same reference numerals as in the vortex-type flow control valve 11.

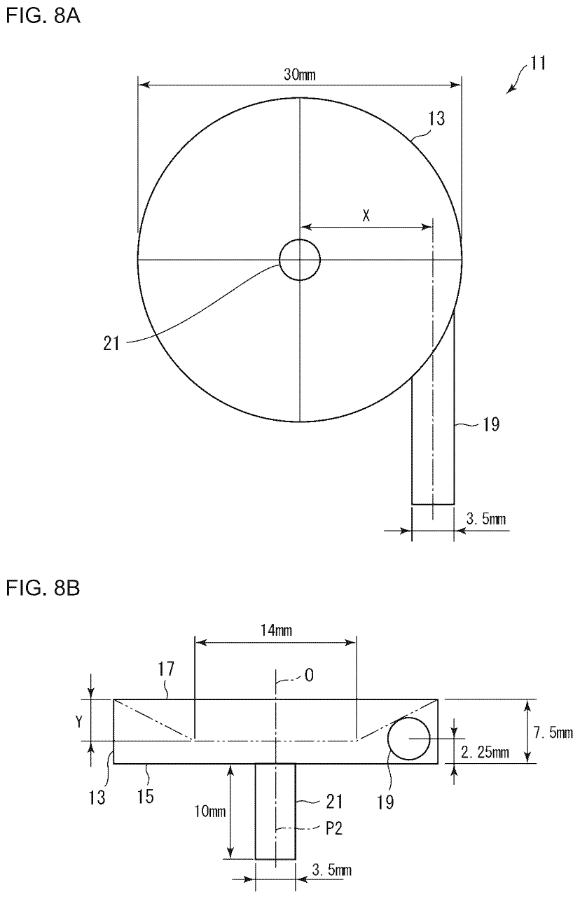

In the following description, unless otherwise specified, as shown in FIGS. 8A and 8B, the simulation was performed under the condition where the vortex chamber 27 had a circular cylindrical shape with a diameter of 30 mm and a height of 7.5 mm, the inlet flow passage 19 having a straight circular pipe shape with a diameter of 3.5 mm was connected to the peripheral side wall 13 such that the inlet flow passage central axis P1 extended through a position away from a position half the height of the vortex chamber 27 (that is, the distance between the first end wall 15 and the second end wall 17) toward the first end wall 15 by 1.5 mm, that is, a position away from the first end wall 15 by 2.25 mm, the outlet flow passage 21 having a circular pipe shape with a diameter of 3.5 mm and a length of 10 mm extended along the vortex chamber central axis O and was connected to the first end wall 15 such that the outlet flow passage central axis P2 extended through the center of the first end wall 15, and a circular region having a diameter of 14 mm concentric with the second end wall 17 was pressed and moved by the drive unit 25. The position of the inlet flow passage 19 with respect to the outlet flow passage 21 was defined as a ratio (%) of a distance between the center of the vortex chamber 27 (that is, the outlet flow passage central axis P2 of the outlet flow passage 21) and the inlet flow passage central axis P1 of the inlet flow passage 19 to a value obtained by dividing a difference between the diameter of the vortex chamber 27 having the circular cylindrical shape and the diameter of the inlet flow passage 19 having the circular pipe shape by 2. This is because the inlet flow passage 19 can only be provided away from the center of the vortex chamber 27 until the inlet flow passage central axis P1 is as far from the peripheral side wall 13 as a radius of the inlet flow passage 19.

First, a relationship between the movement distance (mm) from the home position of the diaphragm constituting the second end wall 17 and the flow rate Q of the fluid flowing out into the outlet flow passage 21 was checked. Here, the home position of the diaphragm is a position of the diaphragm when the diaphragm is not pressed by the drive unit 25. The simulations were performed for various positions of the inlet flow passage 19 with respect to the outlet flow passage 21.

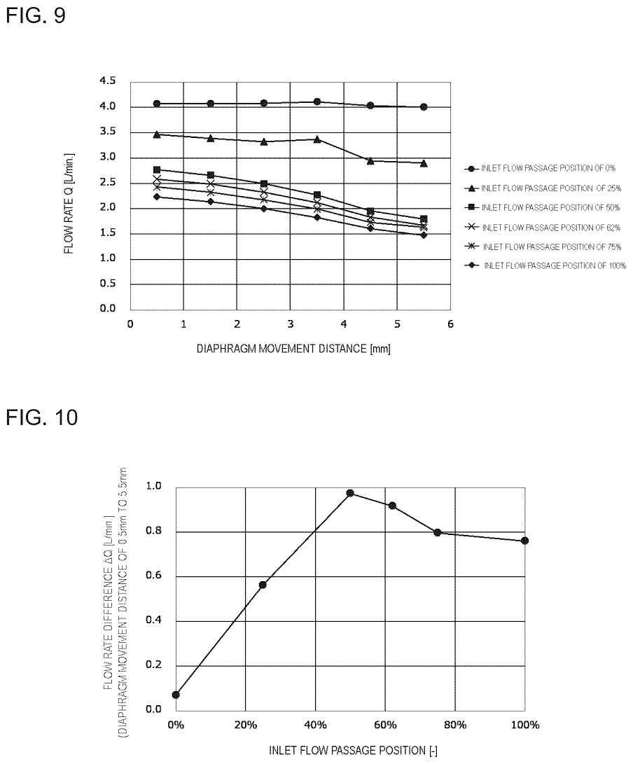

FIG. 9 is a line graph plotting a relationship between the movement distance (mm) from the home position of the diaphragm (second end wall 17) and the flow rate Q (L/min.) of the fluid flowing out into the outlet flow passage 21, which relationship was obtained by the simulation, for cases in which the position of the inlet flow passage 19 with respect to the outlet flow passage 21 was 0%, 25%, 50%, 62%, 75%, and 100%. In FIG. 9, a symbol “•” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 0%, a symbol “▴” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 25%, a symbol “▪” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 50%, a symbol “x” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 762%, a symbol “*” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 75%, and a symbol “♦” indicates a relationship between the movement distance (mm) from the home position of the diaphragm (second end wall 17) and the flow rate Q (L/min.) of the fluid flowing out into the outlet flow passage 21 in a case where the position of the inlet flow passage 19 with respect to the outlet flow passage 21 was 100%.

From FIG. 9, it was confirmed that the flow rate Q of the fluid flowing out into the outlet flow passage 21 was lower as the distance over which the diaphragm, which is the second end wall 17, moved from the home position toward the first end wall 15 was larger, that is, as the distance between the first end wall 15 and the second end wall 17 was smaller, except for a case where the inlet flow passage 19 was located at a position of 0% with respect to the outlet flow passage 21. It is presumed that this is because, in a case where the movement distance from the home position of the diaphragm is longer, the area through which the fluid can pass is narrower to thereby increase the flow velocity, and the flow line from the inlet flow passage 19 to the outlet flow passage becomes longer in a case where a vortex flow is generated in the vortex chamber 27, so that the pressure loss is likely to be increased as the flow velocity is increased. Specifically, when the inlet flow passage central axis P1 is in a positional relationship where the inlet flow passage central axis P1 does not intersect with the outlet flow passage central axis P2, the fluid flowing in from the inlet flow passage 19 collides with the peripheral side wall 13 in the vortex chamber 27, flows along the peripheral side wall 13 to generate the vortex flow, and flows toward the outlet flow passage 21. Therefore, the length of the flow line from the inlet flow passage 19 to the outlet flow passage 21 becomes longer. When the diaphragm, which is the second end wall 17, moves from the home position toward the first end wall 15, the distance between the first end wall 15 and the second end wall 17 becomes shorter to increase the flow velocity of the vortex flow in the vortex chamber 27 and increase the pressure loss. As a result of this increase in the pressure loss, the flow rate of the fluid flowing out into the outlet flow passage 21 is decreased.

In addition, from FIG. 9, it can be seen that the flow rate Q of the fluid flowing out into the outlet flow passage 21 is lower as the inlet flow passage 19 is provided such that the inlet flow passage central axis P1 extends through a position farther away from the outlet flow passage central axis P2. It is presumed that this is because the flow line of the vortex flow from the inlet flow passage 19 to the outlet flow passage 21 is longer and the pressure loss is larger as the inlet flow passage central axis P1 is provided farther from the outlet flow passage central axis P2.

As described above, in a case where the inlet flow passage 19 is provided such that the inlet flow passage central axis P1 extends through a position away from the outlet flow passage central axis P2, the flow rate Q of the fluid flowing out into the outlet flow passage 21 is changed in accordance with the movement distance from the home position of the second end wall 17, and there is a correlation between the movement distance from the home position of the second end wall 17 and the flow rate Q. Therefore, the flow rate Q can be changed by changing the movement distance from the home position of the second end wall 17 to adjust and control the flow rate Q.

Next, an influence of the position of the inlet flow passage 19 in the vortex chamber 27 was checked by the simulation. Here, the simulation was performed for cases where the position of the inlet flow passage 19 with respect to the outlet flow passage 21 was 0%, 25%, 50%, 62%, 75%, and 100% under the condition where the outlet flow passage 21 was connected to the first end wall 15 so as to extend from the center of the vortex chamber 27.

FIG. 10 is a line graph plotting a relationship between the position of the inlet flow passage 19 with respect to the outlet flow passage 21 and the flow rate difference ΔQ (L/min.), which relationship was obtained by changing the movement distance in a direction from the home position of the diaphragm, which is the second end wall 17, toward the first end wall 15 in a range from 0.5 mm to 5.5 mm. From FIG. 10, it was found that, under the condition where the outlet flow passage 21 was connected to the first end wall 15 so as to extend from the center of the vortex chamber 27, the flow rate difference ΔQ could be generated in accordance with the movement distance of the second end wall 17 regardless of the position of the inlet flow passage 19 with respect to the outlet flow passage 21. Therefore, it is possible to adjust the flow rate of the fluid flowing out into the outlet flow passage 21 by moving the second end wall 17 of the vortex-type flow control valve 11 regardless of the position of the inlet flow passage 19 with respect to the outlet flow passage 21. In addition, it was found that the largest flow rate difference ΔQ was generated in a case where the position of the inlet flow passage 19 with respect to the outlet flow passage 21 was 50% and the flow rate could be adjusted over a wider range. Therefore, in a case where flow rate adjustment over a wide range is required, it is preferable to provide the inlet flow passage 19 such that the position of the inlet flow passage 19 with respect to the outlet flow passage 21 is a position of 50%.

Although the vortex-type flow control valve according to the present invention has been described with reference to the shown embodiment, the present invention is not limited to the shown embodiment. For example, in the shown embodiment, the circular cylindrical vortex chamber 27 is adopted, but an elliptical or polygonal cylindrical vortex chamber can also be adopted as long as the vortex flow can be generated in the vortex chamber 27. In addition, since the flow rate Q can be changed by moving the second end wall 17 with respect to the first end wall 15 to change the gap, the protruding portion 29 may be provided on the first end wall 15 as in the third embodiment shown in FIG. 11. Further, as in the fourth embodiment illustrated in FIG. 12, the distance between the first end wall 15 and the second end wall 17 may be changed by moving the second end wall 17′ toward the first end wall 15 along the peripheral side wall 13.

### DESCRIPTION OF REFERENCE NUMERALS

11 vortex-type flow control valve
11′ vortex-type flow control valve
11″ vortex-type flow control valve
13 peripheral side wall
15 first end wall
17 second end wall
17a movable portion
17b supporting portion
17′ second end wall
19 inlet flow passage
21 outlet flow passage
25 drive unit
27 vortex chamber

1. A vortex-type flow control valve comprising: a vortex chamber defined by a cylindrical peripheral side wall, a first end wall, and a second end wall, said first end wall and said second end wall provided opposite each other at both ends of the peripheral side wall, said vortex chamber extending along a vortex chamber central axis; an inlet flow passage extending along an inlet flow passage central axis and being opened in the peripheral side wall; and an outlet flow passage extending along an outlet flow passage central axis and being opened in the first end wall, said vortex-type flow control valve configured such that fluid flowing in from the inlet flow passage generates a vortex flow in the vortex chamber and flows out into the outlet flow passage,
wherein the inlet flow passage is provided such that the inlet flow passage central axis extends through a position away from the vortex chamber central axis and the outlet flow passage central axis, and the second end wall is configured to be movable closer to or away from the first end wall by a drive unit, said vortex-type flow control valve configured such that a flow rate of the fluid flowing out into the outlet flow passage is adjusted in accordance with an amount of movement of the second end wall with respect to the first end wall.

2. The vortex-type flow control valve according to claim 1, wherein the second end wall is constituted by a diaphragm moved closer to or away from the first end wall by the drive unit.

3. The vortex-type flow control valve according to claim 2, wherein the diaphragm includes a movable portion moved by the drive unit, and an elastically deformable supporting portion which is connected to an outer peripheral edge of the movable portion and supports the movable portion.

4. The vortex-type flow control valve according to claim 2, wherein the diaphragm includes a movable portion moved by the drive unit, and a flexible or bendable supporting portion which is connected to an outer peripheral edge of the movable portion and supports the movable portion.

5. The vortex-type flow control valve according to claim 1, wherein the outlet flow passage is provided such that the outlet flow passage central axis extends on the vortex chamber central axis.

6. The vortex-type flow control valve according to claim 2, wherein the first end wall is provided thereon with a protruding portion protruding toward the diaphragm.

7. The vortex-type flow control valve according to claim 1, wherein the first end wall and the second end wall have a circular shape or an elliptical shape.
